(19) United States
(12) Patent Application Publication
(10) Pub. No.: US 2008/0238983 A1
(43) Pub. Date: Oct. 2, 2008

(54) Image forming apparatus

(75) Inventor: Yoshikazu Takahashi, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 12/077,889

(22) Filed: Mar. 21, 2008

(30) Foreign Application Priority Data
Mar. 27, 2007 (JP) 2007-081054

(51) Int. Cl. B41J 2/165

(52) U.S. Cl. 347/23

(57) ABSTRACT

An image forming apparatus is provided. The image forming apparatus includes a carriage comprising a recording head that ejects a liquid toward a recording medium, the carriage configured to reciprocate along a travel path in a widthwise direction of the recording medium; a receiving unit disposed in a position opposed to the recording head so as to receive a fluid which is flushed from the recording head; and a movement device configured to move the receiving unit below the travel path of the carriage to a position which is outside and proximate to an edge in the widthwise direction of the recording medium.

### CROSS-REFERENCE TO RELATED APPLICATIONS

This application claims priority from Japanese Patent Application No. 2007-081054 filed on Mar. 27, 2007, the entire subject matter of which is incorporated herein by reference.

### TECHNICAL FIELD

Apparatuses consistent with the present invention relate to an image forming apparatus and, more particularly, to an image forming apparatus that records information on a recording medium by ejecting a liquid.

### BACKGROUND

A related art image forming apparatus ejects a liquid toward a recording medium such as plain paper and the liquid adheres to a surface of the recording medium in order to express and record a character, a picture, and the like, by an aggregation of dots. Droplets are ejected at high speed toward the recording medium from a plurality of minute nozzles provided in a nozzle surface of a recording head. Hence, when the nozzles are clogged by thickened ink or dust or when air bubbles arise in the nozzles, there arises a problem, such as an ejection failure, a decrease in the accuracy of ejecting of the droplets, variations in quantities of ink to be ejected, and the like, which results in deterioration of image quality.

In order to decrease the occurrence of such problems, there have been proposed various preventative processes. For example, a purging process may be performed in order to discharge extraneous matter, such as a thickened liquid, in nozzles or in an ink supply passage by suction or pressurization. Similarly, a flushing process may be performed to eject a liquid from respective nozzles irrespective of record data. Also, a nozzle preservation procedure may be performed to prevent drying of a liquid in the nozzles when the image forming apparatus is out of use, and so on.

In the flushing procedure, the recording head is moved to a flushing point outside a print area every time the recording head performs recording in one path or several paths with regard to a widthwise direction (i.e., the direction of a main scan) of a recording medium, and the nozzles are then caused to eject a liquid toward a flushing receiving unit provided at the flushing point (i.e., processing called sacrificial ejection or blank ejection). The flushing receiving unit for receiving waste liquid discharged from the nozzles by such a flushing process is fixedly placed at one location.

However, this flushing procedure has some disadvantages. For example, when a small recording medium among usable recording mediums of various sizes is subjected to recording, the carriage moves to the flushing position every time flushing processing is performed. Accordingly, since the flushing position is located separately from the recording medium, it becomes difficult to increase recording speed.

Specifically, when the recording medium is conveyed by a center reference along which the recording medium is sent such that the widthwise center of the recording medium passes through the center of a recording area in the direction of movement of the carriage, or when the recording medium is conveyed along an edge reference while being aligned to one edge of the recording area in the direction of movement of the carriage and when the flushing receiving unit is situated on the side opposite to the edge reference, a distance between the side edge of the small recording medium and the flushing receiving unit becomes long.

Japanese Patent No. 2971635, at page 4, FIGS. 1 and 2, describes a related art inkjet recorder which attempts to shorten a recording time by placing multiple flushing receiving units at locations corresponding to respective widths of a plurality of types of recording mediums.

### SUMMARY

Aspects of the present invention provide an image forming apparatus which eliminates structural waste while increasing recording speed of recording mediums of various widths.

### BRIEF DESCRIPTION OF THE DRAWINGS

FIG. 1 is an exemplary perspective view of an image forming apparatus according to an illustrative aspect of the present invention;

FIG. 2A is an exemplary plan view showing a state where a recording medium having a large width is used in the image forming apparatus of FIG. 1, and FIG. 2B is an exemplary side view of a flushing receiving unit of FIG. 2A;

FIG. 3A is an exemplary plan view showing a state where a recording medium having a small width is used in the image forming apparatus of FIG. 1, and FIG. 3B is an exemplary side view of a flushing receiving unit of FIG. 3A;

FIG. 4A is an exemplary perspective view of an image forming apparatus according to another illustrative aspect of the present invention, and FIG. 4B is an exemplary perspective view showing a state where a recording medium having a large width is used in the image forming apparatus of FIG. 4A; and

FIG. 5 is an exemplary plan view of a sheet feeding tray of an image forming apparatus according to another illustrative aspect of the present invention.

### DETAILED DESCRIPTION

### <General Overview>

According to an aspect of the present invention, there is provided an image forming apparatus including: a carriage including a recording head that ejects a liquid toward a recording medium, the carriage configured to reciprocate along a travel path in a widthwise direction of the recording medium; a receiving unit disposed in a position opposed to the recording head so as to receive a fluid which is flushed from the recording head; and a movement device configured to move the receiving unit below the travel path of the carriage to a position which is outside and proximate to an edge in the widthwise direction of the recording medium.

According to another aspect of the present invention, there is provided an image forming apparatus including: a carriage including a recording head which includes a plurality of nozzles for ejecting a liquid toward a recording medium, the carriage being configured to reciprocate in a widthwise direction that is orthogonal to a direction of movement of the recording medium; a flushing receiving unit which is disposed so as to oppose a surface of the recording head in which the plurality of nozzles are formed and which is configured to receive a waste fluid ejected from the plurality of nozzles; and a movement device which is configured to move the flushing receiving unit to a position which is below a travel path of the carriage and which is a lateral position outside and proximate to an edge of the recording medium in the widthwise direction.

According to yet another aspect of the present invention, there is provided a flushing device for use in an image forming device including: a carriage having a recording head moveably mounted thereon, the flushing device including an endless belt which is disposed along a widthwise direction of a recording area of the image forming device; a drive roller disposed at an end of the endless belt; a driven roller disposed at another end of the endless belt such that the endless belt is reversely rotatable about the drive roller and the driven roller; a motor which rotates the drive roller in order to move the endless belt; and a flushing receiving unit which is disposed in opposition to the recording head on the carriage and is movable by the endless belt along a travel path which corresponds to a travel path of the carriage.

### <Illustrative Aspects>

Illustrative aspects of the present invention will be described with reference to the drawings.

The related art inkjet recorder as described in Japanese Patent No. 2971635 still has a number of disadvantages. For example, in the related art inkjet recorder as described in Japanese Patent No. 2971635, the flushing receiving units are provided at a plurality of locations corresponding to the widths of respective types of recording mediums. Flushing receiving units assigned to the recording mediums which are used with less frequency or low frequency are not much utilized. This creates waste in that many flushing receiving units are not used and are thus redundant. Moreover, when a recording medium having a large width is conveyed, the recording medium covers the upper surfaces of some flushing receiving units. When the recording medium contacts wasted liquid in the flushing receiving units, because of for example deformation in the recording medium, the recording medium is stained with the liquid, and the stain may spread through the inside of the image forming apparatus, as well.

Aspects of the present invention provide an image forming apparatus which eliminates structural waste while increasing recording speed of recording mediums of various widths.

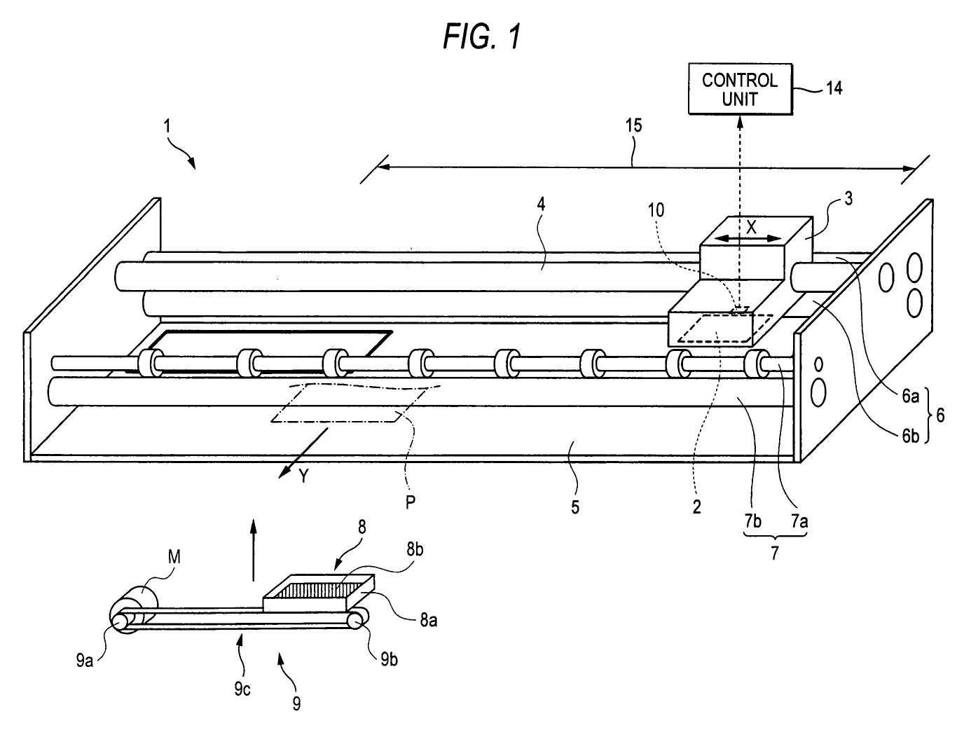

FIG. 1 is a general perspective view of an image forming apparatus 1 according to an illustrative aspect of the present invention. For simplicity of description, a flushing receiving unit 8 and a movement unit 9 thereof, which will be described later, are separated from the image forming apparatus 1.

As shown in FIG. 1, the image forming apparatus 1 includes a recording head 2 that ejects a liquid, for example, ink, toward a recording medium P, to thus perform recording; a carriage 3 including the recording head 2; a guide member 4 to which the carriage 3 is attached; a chassis 5 on which the various components are mounted; a pair of upper and lower feed rollers 6; a pair of upper and lower discharge rollers 7; a flushing unit 8; a moving unit 9 for moving the flushing unit 8; and a control unit 14 for controlling the overall operation of the image forming apparatus 1.

The carriage 3 reciprocally moves in a widthwise direction (a main scan direction) of the recording medium P indicated by arrow X in the drawing along the guide member 4 extending across the chassis 5 in the main scan direction X. The carriage 3 is driven by an unillustrated endless belt (not shown) that can rotate forwardly and backwardly. The carriage 3 includes an optical medium sensor 10 for detecting a recording medium. The control unit 14 moves the carriage 3 in the main scan direction while the recording medium P is situated at a position opposing the medium sensor 10, thereby enabling detection of the width of the recording medium P in accordance with a detection signal from the medium sensor and the amount of travel of the carriage 3. Further, the control unit 14 detects an edge of the recording medium P in a sub-scan direction Y (to be described in more detail later) by the medium sensor 10, thereby controlling initiation or stoppage of recording operation of the recording head 2.

The recording head 2 is placed on the surface of the carriage 3 opposing the recording medium P. The surface of the recording head 2 opposing the recording medium P acts as a nozzle surface. A plurality of nozzle columns that are long in a direction orthogonal to the main scan direction X are formed, in the nozzle surface, side by side for respective colors of ink to be ejected. Ink ejected from the recording head 2 is supplied from an ink cartridge (not shown). In some cases, the ink cartridge is mounted on the carriage 3. In other cases, the ink cartridge is placed aside from the carriage 3. Ink is supplied from the separately-positioned ink cartridge by way of a flexible tube (not shown).

An upper portion 6a of the feed roller 6 serves as a driven side, and a lower portion 6b of the feed roller 6 serves as a driving side. The recording medium P is conveyed to a position below the carriage 3 along a direction (the sub-scan direction Y) orthogonal to the main scan direction X while being sandwiched between the driven-side feed roller 6a and the driving-side feed roller 6b.

An upper portion 7a of the pair of up and lower discharge rollers 7 serves as a driven-side, and a lower portion 7b of the same serves as a driving side. The recording medium P having finished undergoing recording is conveyed to the outside of the image forming apparatus 1 while being sandwiched between the driven-side discharge roller 7a and the driving-side discharge roller 7b.

In the image forming apparatus 1 shown in FIG. 1, a maximum width over which the image forming apparatus can perform a recording operation in the main scan direction X is taken as a recording area 15, and recording mediums P of various widths are conveyed along a center reference while being aligned to the center of the recording area 15 in the main scan direction X. Specifically, the recording medium P is conveyed in such a way that the widthwise center of the sheet passes through the center of the recording area 15 in the main scan direction X. As a result of the feed roller 6 and the discharge roller 7 being arranged so as to be symmetrical with respect to the center, the pressure of the roller can be exerted uniformly over recording mediums P of various sizes in the widthwise direction thereof, so that highly-accurate conveyance of the recording medium is possible.

When viewed from above, the flushing receiving unit 8 is located between the feed roller 6 and the discharge roller 7, on one side with respect to the main scan direction X, and below a travel path of the carriage, so as to oppose, while being spaced at a distance from, the nozzle surface of the recording head 2. The flushing receiving unit 8 is driven by an endless belt 9C and can reciprocally travel, in the main scan direction X, between lateral positions outside a recording medium P having the maximum width recordable in the image forming apparatus and lateral positions outside the recording medium P having the minimum width.

The flushing receiving unit 8 stores, in a box-shaped container 8a whose upper surface is open, a porous ink foam 8b for absorbing ink. The flushing receiving unit 8 is placed with its open upper surface being directed toward the carriage 3. In the moving unit 9, the endless belt 9C is passed between a drive roller 9a connected to a motor M and a driven roller 9b and can travel in the main scan direction X. The endless belt 9C and the flushing receiving unit 8 are coupled together, and the endless belt 9C is caused to travel, thereby enabling movement of the flushing receiving unit 8.

The carriage 3 travels in the main scan direction X over the recording area 15 and the flushing positions opposing the flushing receiving unit 8 situated at lateral positions outside the recording area 15.

Although omitted from the drawings, there are provided a purging device, which discharges extraneous matter such as thickened ink by bringing a cap into contact with the nozzle surface of the recording head 2 and performing absorption or pressurization, and a maintenance unit made up of a cap and the like for preventing drying of ink in the nozzles by covering the nozzle surface when the image recording apparatus is out of use. The cap can also be provided beside the flushing receiving unit 8 in such a way that the cap can be moved by the endless belt 9C. Further, the cap can be caused to act also as the flushing receiving unit 8, thereby receiving ink ejected by flushing.

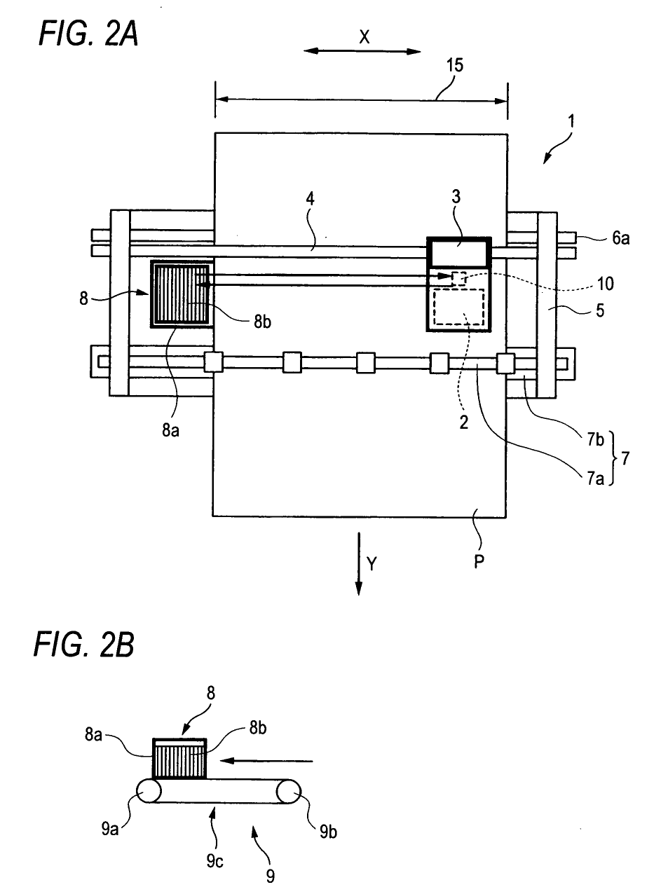

Operation of the image forming apparatus 1 will now be described with reference to FIGS. 2A and 2B. A recording medium P having a size; for example, an A4-size recording medium, is set on an feed tray (not shown). The recording medium P is set on the feed tray while being aligned to the widthwise center of the recording area 15. The feed roller 6 is driven, to thus convey the recording medium P to a position opposing the medium sensor 10 of the carriage 3. The carriage 3 is moved in the main scan direction X, and the width of the recording medium P is detected by the medium sensor 10 and the control unit 14. In accordance with the width, the control unit 14 drives the endless belt 9C, thereby moving the flushing receiving unit 8 to a position in close proximity to the edges of the recording medium but outside the recording medium P in the travel path of the carriage 3 when viewed from above (FIGS. 2A and 2B). The feed roller 6 is again driven, thereby conveying the recording medium P to a position opposing the recording head 2, and recoding is performed.

The recording medium P is subjected to recording by ejecting ink droplets from the nozzles of the recording head 2 toward the recording medium P while the carriage 3 is reciprocally moved in the main scan direction X. Every time the carriage 3 is moved once in the main scan direction X (i.e., along one path), the recording medium P is conveyed a predetermined distance at a time in the sub-scan direction Y. With a view toward maintaining and recovering ejection function of the nozzles during the course of recording operation, the carriage 3 is moved to a position above the flushing receiving unit 8 every time a threshold number of paths are subjected to recording, and the respective nozzles are caused to eject ink toward the flushing receiving unit 8. Since the flushing receiving unit 8 is situated at a location proximate to an edge of a sheet, the travel distance of the carriage 3 becomes shorter, and recording can be performed quickly and efficiently.

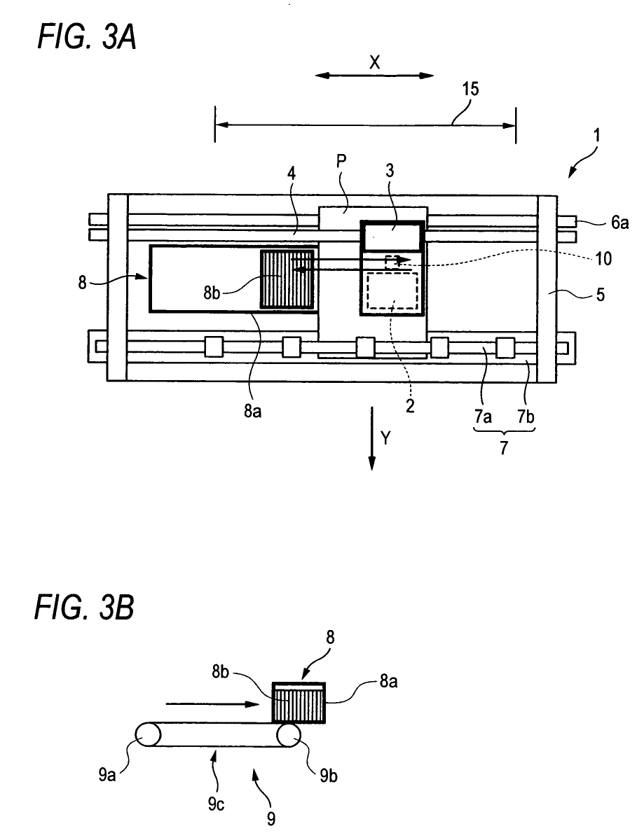

When the size of the recording medium P is changed, the flushing receiving unit 8 is automatically moved to a location where the flushing receiving unit comes in closely proximity to an edge of the recording medium, in accordance with the width of the recording medium P detected as mentioned previously. Therefore, the changed recording medium P can also be subjected to quick and efficient recording (FIGS. 3A and 3B). FIG. 3 shows a case where a recording medium P having a width smaller than the recording area 15 of the image forming apparatus 1 is to be printed. For example, the recording medium P may be a post card. As mentioned above, the flushing receiving unit 8 can be used commonly among various recording mediums P regardless of the width of the recording medium P, and hence no structural waste arises. Moreover, the flushing receiving unit 8 is not located at a position below a recording medium having a large width, and hence there is no potential risk of the recording medium being stained.

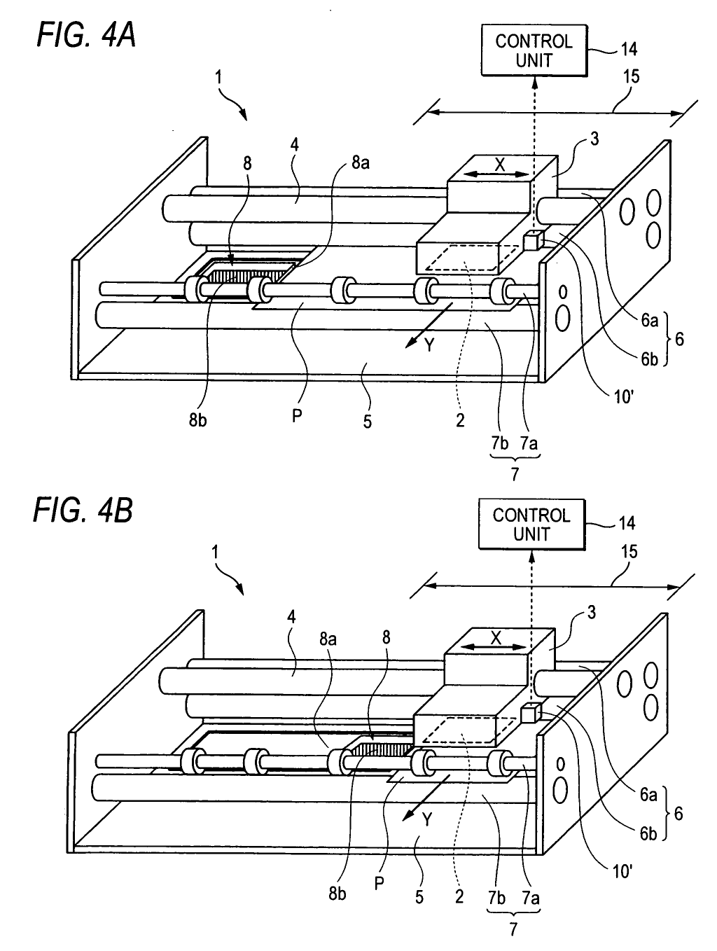

FIGS. 4A and 4B show an image forming apparatus according to another illustrative aspect of the present invention that conveys the recording mediums P of various widths along an edge reference while being aligned to a single edge of the recording area 15 with respect to the main scan direction X. In this case, when viewed from above, the flushing receiving unit 8 is placed at a position opposite to the edge position serving as the edge reference in the main scan direction. The flushing receiving unit 8 is moved to a position proximate to the edge of the recording medium P in accordance with the width of the recording medium P detected by a medium sensor 10′ and the control unit 14 on the carriage 3. Therefore, the distance over which the carriage 3 is moved with respect to recording mediums P of various widths during the flushing operation is shortened, whereby quick and efficient recording can be performed. In short, as shown in, for example, FIG. 4A, a comparatively-wide recording medium P, such as an A4-size sheet, can be subjected to high-speed recording. Further, as shown in FIG. 4B, a comparatively-narrow recording medium P, such as a postcard, can also be subjected to high-speed recording.

When the size of the recording medium P is scanned by the medium sensor 10′ of the carriage 3, a scan start position can be made common regardless of the size of the recording medium P, so that control can be simplified. The medium sensor 10′ of the image forming apparatus 1 shown in FIGS. 4A and 4B is located on the edge reference side of the carriage 3 so as to support edge reference conveyance. The present inventive concept is also applicable to an image forming apparatus which can switch between the center reference and the edge reference.

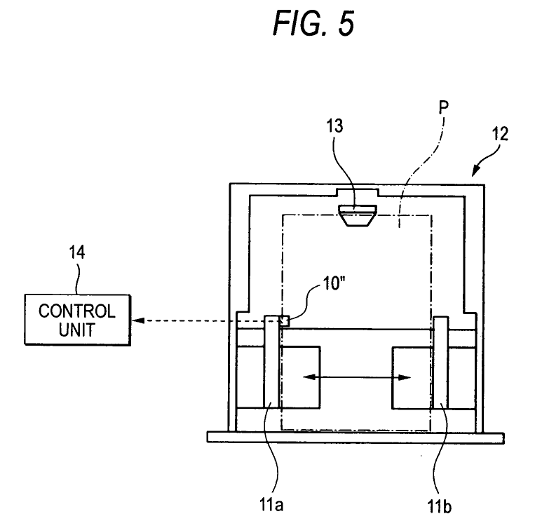

FIG. 5 shows another illustrative aspect according to the present invention. In this illustrative aspect, the width of the recording medium P is detected when the recording medium is placed in a sheet feeding tray (i.e., before the recording medium is fed into the image forming apparatus 1 by the feed rollers 6. FIG. 5 shows a detection unit for use with an image forming apparatus 1 for detecting the width of the recording medium P in such a configuration. FIG. 5 is a plan view of the sheet feeding tray 12. The sheet feeding tray 12 includes a pair of guide units 11a and 11b in the widthwise direction of the recording medium P. When the image forming apparatus 1 conveys the recording medium P along the center reference as described for example with reference to FIG. 2, the pair of guide units 11a and 11b synchronously moves in the widthwise direction with reference to the center. Alternatively, when the recording medium P is conveyed along the edge reference as described for example with reference to FIG. 4, the one guide unit 11b of the reference edge is fixed, and the other guide unit 11a is moved in the widthwise direction. The control unit 14 then detects the width of the recording medium P by detecting the position of the movable guide unit 11a through use of a recording medium detection sensor 10″. The position of the guide unit 11a located, with respect to the recording medium P, on the same side where the flushing receiving unit 8 is situated can also be used as a position where the flushing receiving unit 8 is to be moved. The feed tray 12 is also provided with a guide piece 13 for regulating the length of a recording medium. Alternatively to providing the guide units 11a and 11b on the feed tray 12, the guide units 11a and 11b may also be disposed directly upstream of the feed roller 6 without use of the sheet feeding tray 12.

In the case of using the guide units 11a and 11b, a process for moving the carriage 3 in the widthwise direction of the recording medium P is obviated.

Alternatively, a setting device for setting the size of the recording medium P can also move the flushing receiving unit 8. In this case, the setting device is incorporated in the control unit 14 of the image forming apparatus, and the size of the recording medium P is input by operation of, for example, keys of an operation panel provided on the image forming apparatus. When record data are prepared by an external device, such as a personal computer, size data pertaining to the recording medium P are set. Hence, the control unit 14 reads the size data and moves the flushing receiving unit 8 to a location where the flushing receiving unit is located in close proximity ot an edge of the recording medium based on the size data set. Thus, the detector, such as a sensor for detecting the width of the recording medium P, can be omitted, and structural simplification can be achieved.

In the above-described illustrative aspects of the present invention, the recording medium may be a resin or cloth, and various types of fluids, such as a coloring liquid or a functional liquid, as well as ink can also be applied to a liquid to be ejected.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus comprising:
a carriage comprising a recording head that ejects a liquid toward a recording medium, the carriage configured to reciprocate along a travel path in a widthwise direction of the recording medium;
a receiving unit disposed in a position opposed to the recording head so as to receive a fluid which is flushed from the recording head; and
a movement device configured to move the receiving unit below the travel path of the carriage to a position which is outside and proximate to an edge in the widthwise direction of the recording medium.

2. The image forming apparatus according to claim 1, further comprising:
a detection unit which detects a width of the recording medium,
wherein the movement device moves the receiving unit to the position which is outside and proximate to the edge of the recording medium based on the width of the recording medium.

3. An image forming apparatus comprising:
a carriage comprising a recording head which comprises a plurality of nozzles for ejecting a liquid toward a recording medium, the carriage being configured to reciprocate in a widthwise direction that is orthogonal to a direction of movement of the recording medium;
a flushing receiving unit which is disposed so as to oppose a surface of the recording head in which the plurality of nozzles are formed and which is configured to receive a waste fluid ejected from the plurality of nozzles; and
a movement device which is configured to move the flushing receiving unit to a position which is below a travel path of the carriage and which is a lateral position outside and proximate to an edge of the recording medium in the widthwise direction.

4. The image forming apparatus according to claim 3, further comprising:
a detection unit which detects a width of the recording medium,
wherein the movement device moves the flushing receiving unit according to the width detected by the detection unit.

5. The image forming apparatus according to claim 4, wherein the detection unit comprises a sensor provided on the carriage.

6. The image forming apparatus according to claim 4, further comprising:
a guide unit which is configured to guide the recording medium into the image forming apparatus,
wherein the detection unit comprises a sensor, and the detection unit detects the width of the recording medium based on a location of the guide unit detected by the sensor.

7. The image forming apparatus according to claim 3, further comprising:
a setting device which sets a size of the recording medium,
wherein the movement device moves the flushing receiving unit to the position which is outside and proximate to the edge in the widthwise direction of the recording medium based on the size of the recording medium.

8. The image forming apparatus according to claim 3, wherein the movement device comprises an endless belt that travels in a direction of movement of the carriage and is reversely rotatable.

9. The image forming apparatus according to claim 3, wherein the recording medium is conveyed along a center reference in such a way that a widthwise center of the recording medium passes through a center of a recording area in a direction of movement of the carriage.

10. The image forming apparatus according to claim 3,
wherein the recording medium is conveyed along an edge reference aligned to one edge of a recording area in a direction of movement of the carriage, and
wherein the lateral position outside and proximate to the edge of the recording medium in the widthwise direction is a position that is opposite to the edge reference.

11. A flushing device for use in an image forming device comprising a carriage having a recording head movably mounted thereon, the flushing device comprising:
an endless belt which is disposed along a widthwise direction of a recording area of the image forming device;
a drive roller disposed at an end of the endless belt;
a driven roller disposed at another end of the endless belt such that the endless belt is reversely rotatable about the drive roller and the driven roller;
a motor which rotates the drive roller in order to move the endless belt; and
a flushing receiving unit which is disposed in opposition to the recording head on the carriage and is movable by the endless belt along a travel path which corresponds to a travel path of the carriage.
